(19) United States
(12) Patent Application Publication
(10) Pub. No.: US 2013/0222180 A1
(43) Pub. Date: Aug. 29, 2013

(54) System and Method for Measuring Signal Power

(71) Applicant: Gregory Thane Wyler, Sewalls Point, FL (US)

(72) Inventor: Gregory Thane Wyler, Sewalls Point, FL (US)

(21) Appl. No.: 13/408,304

(22) Filed: Feb. 29, 2012

(51) Int. Cl. G01S 19/48; G01S 19/20

(52) U.S. Cl. 342/357.31; 342/357.58

(57) ABSTRACT

A system and method are disclosed which may include providing a plurality of communication devices having access to the internet and respective GPS systems operable to communicate with a GPS satellite system; and each communication device transmitting a signal, indicative of GPS communication disruption, over the Internet to a back end system whenever (a) its GPS system is turned on; and (b) energy received through a GPS antenna of said communication device is below a level enabling a minimum signal to noise ratio needed for decoding GPS signal data.

### BACKGROUND OF THE INVENTION

Mobile cellular devices such as cellular phones, mobile-communication enabled computers, among other devices have experienced widespread use in recent years, and the popularity of such devices continues to expand. Increasingly, these devices come equipped with Global Positioning System (GPS) circuits, including GPS antennas. With many such devices, users are able to activate and de-activate the GPS circuits within their mobile devices at will.

However, sometimes, even when a user has activated the GPS system (including the GPS antenna) on his or her mobile device, the device concerned is still unable to receive GPS signals with enough strength to decode the GPS transmissions. Disruptions may be caused by several factors including the presence of physical obstructions in between the mobile device and the GPS satellite system, and/or by electromagnetic interference by other RF (radio frequency) signals, whether inadvertently or due to deliberate interference. For instance, deliberate interference may be caused by the use of a GPS jamming device.

Currently, reports of GPS communication outages tend to be sporadic, scattered, and may be biased toward users most likely to report problems, and/or toward users who misuse the equipment they own. This situation complicates the diagnosis and resolution of GPS transmission problems. Accordingly, there is a need in the art for improved systems and methods for reporting and analyzing GPS communication disruptions.

### SUMMARY OF THE INVENTION

According to one aspect, a system and method are disclosed that may include providing a plurality of communication devices having access to the internet and respective GPS systems operable to communicate with a GPS satellite system; and each communication device transmitting a signal, indicative of GPS communication disruption, over the Internet to a back end system whenever (a) its GPS system is turned on; and (b) energy received through a GPS antenna of said communication device is below a level enabling a minimum signal to noise ratio needed for decoding GPS signal data.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a system for obtaining GPS communication status data in accordance with an embodiment of the present invention;

FIG. 2 is a perspective view of a cell phone having a GPS system incorporated therein in accordance with an embodiment of the present invention;

FIG. 3 is a block diagram of a back end system in accordance with one or more embodiments of the present invention;

FIG. 4A is a schematic illustration of a roadway with vehicles thereon, the illustration including indicia of GPS communication status superimposed on the respective vehicles, in accordance with an embodiment of the invention;

FIG. 4B is a schematic illustration of the roadway and vehicles of FIG. 4A, but with different GPS communication status indicia, in accordance with an embodiment of the present invention; and

FIG. 5 is a block diagram of a computer system useable in conjunction with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

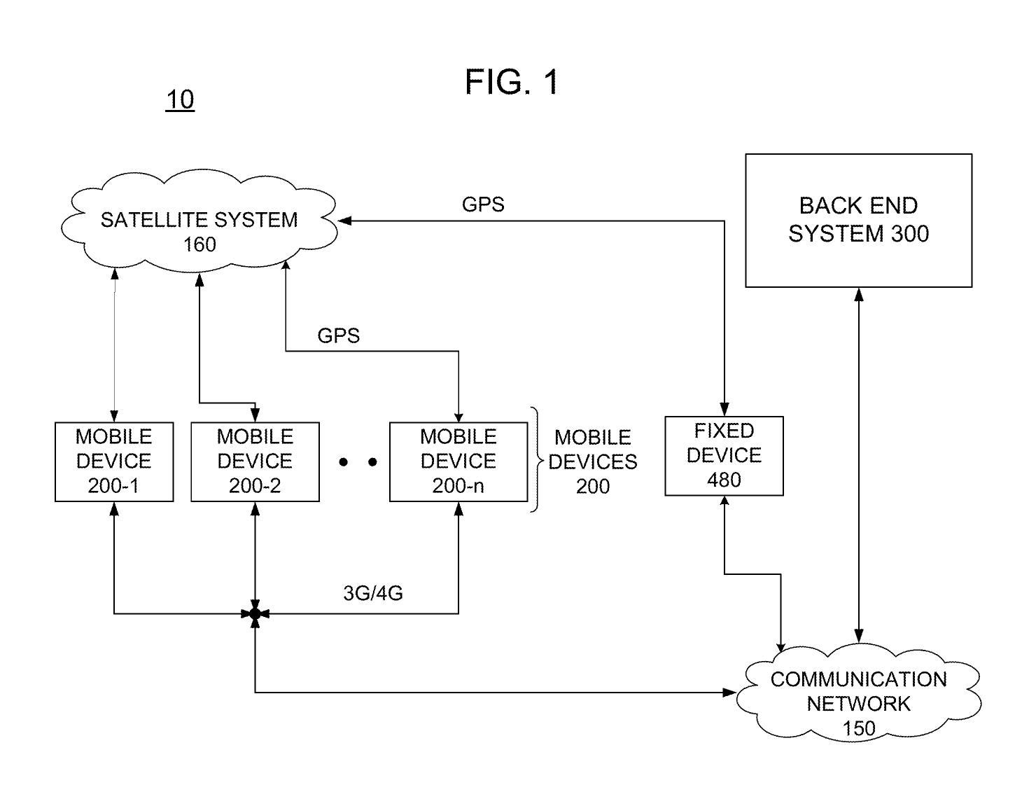

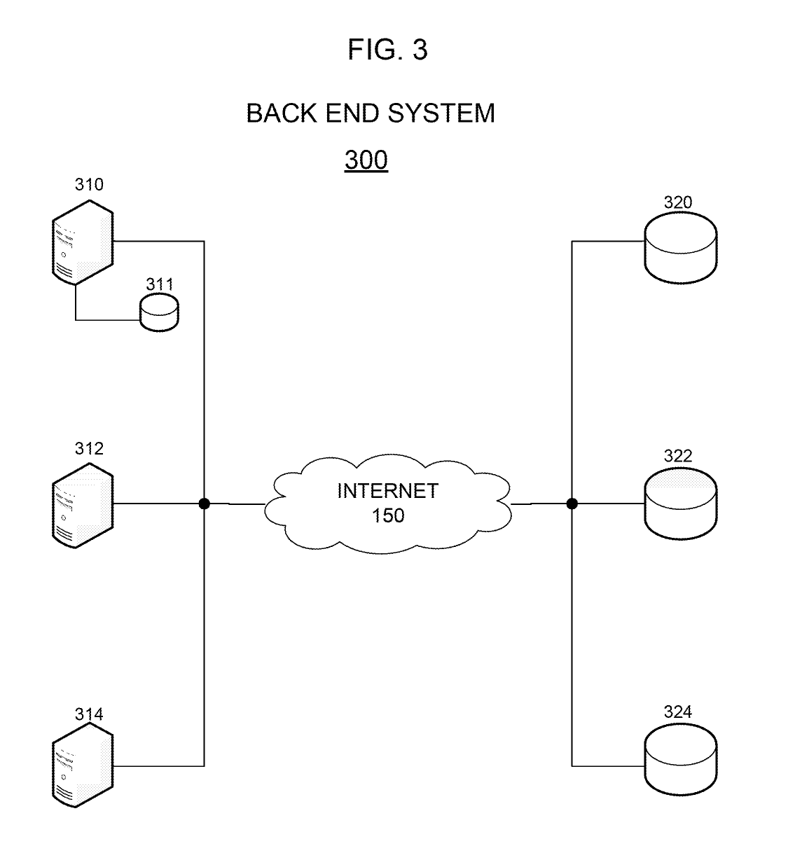

FIG. 1 is a block diagram of a system 10 for obtaining GPS communication status data in accordance with an embodiment of the present invention. System 10 may include communication network 150, which may be the Internet, satellite system 160 which is preferably a GPS-specific satellite system, and/or back end system 300 (discussed in greater detail in connection with FIG. 3). System 10 may further include mobile devices 200 and one or more fixed devices 480 for detecting GPS communication disruption conditions.

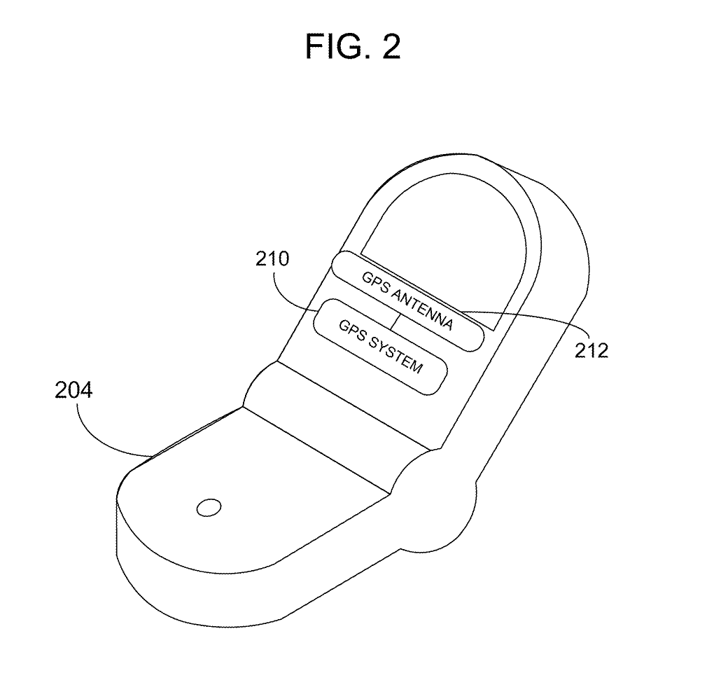

Implementing a mechanism on mobile devices 200 (such as cell phones, computers etc.) that automatically reports GPS signal disruption (among other possible locally prevailing conditions) when the GPS systems 210 (FIG. 2) of the respective devices fail to receive an expected GPS signal effectively converts GPS-enabled communication devices 200 within moving or stationary vehicles into a dispersed, mobile, expandable, and continuously installed base of GPS signal status reporting devices without having to install dedicated equipment for such reporting or to incur the considerable expense of installing such dedicated equipment. Instead, vehicles and mobile devices 200 that were purchased privately to serve their respective owners' purposes may double as GPS signal status reporting devices at either no cost, or at minimal cost, in addition to the purchase price of the GPS-enabled mobile devices themselves. Moreover, once deployment of the auto-reporting of GPS signal disruption is widespread, the presence of GPS signal disruption reporting devices will be essentially as universal throughout the U.S., and indeed the world, as vehicles and human users carrying mobile devices are. Moreover, the number of vehicle-carried and/or user-carried GPS-enabled communication devices will inevitably expand as adoption of GPS technology proliferates, thereby simultaneously expanding the total number of disruption reporting devices. Accordingly, the spatial granularity with which GPS signal disruption reporting may be conducted may increase as the total number of users of GPS-enabled mobile devices increases. If today, a jamming device is never more than a one thousand yards from a GPS-enabled mobile device, in the future, the same jamming device may be never more than one hundred yards from a reporting device. Moreover, the presence of such devices should enable still more complete and progressively more granular GPS signal disruption reporting as time advances, and as GPS-enabled mobile device adoption becomes more widespread.

While automatic reporting of GPS signal failure is discussed above, in alternative embodiments, a human user may enter data pertinent to a “report” of one type of condition or another. Moreover, the user may subsequently instruct the mobile device to transmit a report of the condition to the back end system 300 over the Internet 150.

FIG. 2 shows a cellular phone 204 which is one possible implementation of a mobile device 200. Cell phone 204 may include GPS system 210 which may in turn include GPS antenna 212. Mobile devices 200 may be cell phones 204, computers with cellular communication ability, tablet computers, or probes dedicated solely or substantially only to measuring GPS signal strength and reporting the GPS signal strength data to back end system 300 over the Internet. Dedicated probes 200 may be stationary such as fixed device 480, or may be moveable, by placing such probes 200 on motor vehicles, trains, ships or airplanes.

Either mobile devices 200 or fixed devices 480 may determine the existence of a GPS communication disruption (also referred to herein as “GPS signal failure” or “GPS signal reception failure”) in at least two ways. According to one embodiment, a mobile device 200, such as cell phone 204, may take note of a combination of two conditions: (a) the GPS system 210 is turned on; and (b) the GPS signal energy received by GPS system 210 through GPS antenna 212 is of insufficient strength. The condition of the GPS signal being of insufficient strength may correspond to a range of GPS signal strength extending from (a) there being no GPS signal energy at all on up to (b) a condition in which there is GPS signal energy on antenna 212, but the GPS signal energy is below a level that provides the minimum signal to noise ratio needed for the GPS system 210 to decode the GPS signal data into meaningful location and/or directional data.

In this case, an application installed in cell phone 204 may automatically send a signal over the Internet 150 to back end system 300 that is indicative of the existence of a disruption in GPS communication. The “GPS Communication Disruption Signal” (“GCDS”) may be sent over a 3G, 4G or other common terrestrial wireless communication path that is not dependent on the operating condition of the GPS satellite system 160.

Alternatively, instead of having the GPS communication disruption signal sent automatically by the mobile device 200, a user of the mobile device 200 experiencing the disruption of its GPS signal may initiate the transmission of the GCDS using any one of a plurality of possible means including but not limited to: (a) pressing a hard button on the mobile device 200; (b) pressing a soft button on a display screen on mobile device 200; (c) issuing a voice command to mobile device 200; (d) scanning an image indicative of the GCDS condition by the mobile device 200 which thereby causes the mobile device 200 to transmit the GCDS to the back end system over the internet; and/or provide other light input to the mobile device 200. Otherwise stated, a user-initiated transmission of the GCDS may be activated using one or more methods of input to the mobile device including but not limited to tactile input (i.e. soft or hard button contact); voice or other audio input; image scanning; or other form of optical/light input to the mobile device 200.

In another embodiment, a mobile device 200 or fixed device 480 may determine the existence of a disruption in GPS communication by directly sensing the presence of a deliberately generated GPS jamming signal. This signal may be transmitted by having a user manually enter a command, or may be transmitted automatically once the mobile device 200 or fixed device 480 detects the jamming signal.

Back end system 300 of FIG. 3 generally provides the opportunity to accumulate, analyze, and correlate GPS communication disruption data using a cloud-based system that may be located at one or more locations within the Internet. In this manner, processing power, data storage facilities, and/or access to other pertinent data to correlate the GPS communication disruption reports with (such as GPS communication disruptions reported by other users, weather events, jamming signal detection events; natural disasters, etc.) may be accessed and used on an as-needed basis, without necessarily having to permanently allocate the above-listed computer resources to system 10, and thereby incur wasted down time.

However, in an alternative embodiment, computer resources sufficient to handle any and all requirements of system 10 could be permanently allocated for use by system 10. Moreover, the permanently allocated computer resources could all be located within one local area network (i.e. one location on the Internet) or may be distributed over a number of locations on the Internet.

Back end system 300 may include computer systems 310, 312, and 314; and/or data storage facilities 320, 322, and 324. Computer system 310 is shown including a local data storage device 311, which may also be referred to as database 311. However, any of the computer systems shown in FIG. 3 may also include local data storage. While three computer systems and three data storage facilities are shown in FIG. 3, it will be appreciated that fewer or more than three computing systems, and fewer or more than three data storage facilities may be configured for use with back end system 300. The equipment of back end system 300 may be concentrated at one location. However, alternatively, the various operational components of back end system 300 may be distributed over the Internet 150 and may communicate with one another over the “cloud” as needed. Moreover, the functionality of back end system 300 need not be permanently assigned to any fixed set of hardware devices. Instead, the functionality and/or data storage of back end system 300 may be migrated to other computing systems, as needed. Thus, for instance, the data stored in communal database 311 is not limited to being stored in storage device 311, but may instead be distributed over any number of data storage devices accessible by the processing ability of back end system 300.

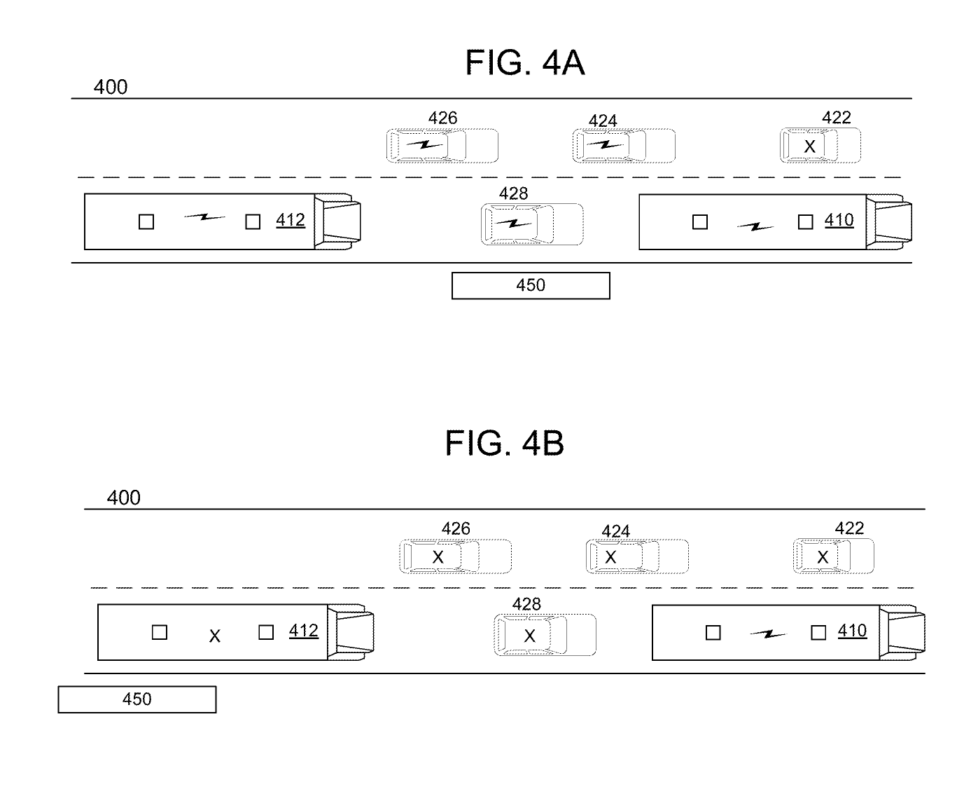

FIG. 4A is a schematic illustration of a roadway 400 with vehicles on it, the illustration including indicia of GPS communication status superimposed on the images of the respective vehicles. FIG. 4B is a schematic illustration of the roadway and vehicles of FIG. 4A, but with different GPS communication status indicia, in accordance with an embodiment of the present invention. The GPS communication status indicia are intended to refer to the GPS communication status of mobile communication devices located inside the respective vehicles.

FIGS. 4A and 4B (collectively FIG. 4) illustrate two possible sets of GPS disruption data sets that may arise from a given set of vehicles on the same roadway 400. FIG. 4 shows but one example of a circumstance that can cause users to generate GPS communication disruption data that may at first appear random, but which, with suitable analysis, may be resolved into a coherent pattern of GPS disruption, thereby hopefully aiding in removing the cause of the disruption. In the case illustrated in FIG. 4, as will be described below, reports of GPS communication disruption that are correlated in place and time may enable a machine or person to form at least a reasonable suspicion and possibly a conclusion as to the cause of the disruption. In other circumstances correlation with factors other than the place and time of the respective disruptions may be employed to glean a common causal factor from GPS communication disruption reports that appear to be random at first glance.

FIG. 4A shows roadway 400 with vehicles 422, 424, 426, 428, 410, and 412, and fixed device 450 thereon. For the sake of compactness, two symbols are used to denote two respective conditions for GPS signal reception for mobile communication devices within the respective vehicles. The “X” symbol indicates a GPS signal reception failure, and the “Z” shaped symbol (which is stretched out horizontally) denotes active GPS signal reception. Fixed device 450 is “fixed” with respect to roadway 400 and is therefore not mobile along with the above-listed vehicles with respect to roadway 400. In contrast, for the sake of the example discussed below, all of the vehicles shown in FIGS. 4A and 4B are considered to be in motion at approximately the same speed (roughly at ordinary vehicle highway speed) with respect to roadway 400, toward the right in the view of FIGS. 4A and 4B.

We first direct attention to FIG. 4A. The two trucks 410 and 412 both have the indicia of successful GPS signal reception for the mobile devices therein, as do the automobiles 424, 426, and 428. The mobile device in vehicle 422 is experiencing GPS communication disruption, as shown with the “X” on vehicle 422 in FIG. 4A. Thus, in accordance with an embodiment of the present invention, the mobile device in vehicle 422 preferably automatically transmits a GPS communication disruption signal to back end system 300 via the Internet 150, using a 3G, 4G or other communication link that is independent of the GPS radio-frequency link.

### Data Accompanying Report of GPS Signal Failure

The report of a GPS signal failure to back end system 300 is preferably accompanied by other information that may aid in deducing the cause of the GPS signal failure. This additional information may include, but is not limited to: (a) the location of vehicle 422 at the time of the GPS signal failure; (b) the time at which the failure occurred (which time report preferably specifies a time zone so that there is no ambiguity regarding the reported time data); and/or additional data such as, but not limited to, the brand and model of the mobile device, applications that are active in the mobile device at the time the GPS signal failure was detected, and/or information regarding a past history of GPS signal failures for that mobile device 200. The additional information referred to above may be provided by the mobile device 200 within vehicle 422, and/or by other entities in communication with the mobile device 200 of vehicle 422, such as the telecommunications company providing service to the mobile device within vehicle 422, or one or more data storage components of back end system 300.

The time of day of the GPS signal failure report can be easily determined by any computing entity along the chain of devices from mobile device 200 within vehicle 422 to back end system 300. The location of vehicle 422 at the time of the GPS signal failure could be provided by one or more entities within the cellular service infrastructure and/or by the mobile device within vehicle 422. For instance mobile device 200 within vehicle 422 could report the most recent GPS satellite report of the location of the mobile device within vehicle 422. Alternatively, the cellular communications service company serving mobile device 200 within vehicle 422 could estimate the location of vehicle 422 at the time of the GPS signal failure by triangulating among a plurality of cellular service towers within communication range of mobile device 200 within vehicle 422. In another alternative embodiment, if the mobile device 200 within vehicle 422 is using a WIFI communication hot spot provider, the SSID (Service Set Identifier) of the router for that WIFI hot spot could be used to identify the location of the mobile device 200 within vehicle 422.

With the limited information available in the example of FIG. 4A (i.e. just one report of GPS signal failure), there is likely not enough information to deduce a cause of the GPS signal disruption being experienced by the mobile device 200 within vehicle 422. However, information describing the GPS signal disruption may still be stored on a storage device within back end system 300 for future reference.

We now direct attention to FIG. 4B. FIG. 4B is intended to show roadway 400 somewhat later in time than the situation shown in FIG. 4A. The change in position of the vehicles along roadway 400 in FIG. 4B in relation to that shown in FIG. 4A may be seen by noting the position of the vehicles in relation to fixed device 450. However, the change in the GPS signal reception status of the various vehicles is the subject of primary interest here.

In FIG. 4B, it may be seen that vehicle 410 is reporting successful GPS signal reception for one or more mobile devices located therein. However, all of the other vehicles 412, 422, 424, 426, and 428 are reporting GPS signal reception failure in the situation shown in FIG. 4B. In accordance with methods discussed elsewhere herein, all of the mobile devices within vehicles in FIG. 4B experiencing GPS signal disruption preferably report the GPS signal failure to back end system 300 along with as much additional information as is available to the respective mobile devices 200 at the times of the respective failures. Further information may be added to the GPS signal failure report by the mobile devices themselves, by computing entities associated with wireless telecommunication service providers affiliated with the respective mobile devices 200, and/or from data storage devices accessible by back end system 300.

In a preferred embodiment, a processor, such as may be found within server computer 310 of back end system 300, preferably operates to accumulate the reported GPS signal failure reports, along with additional information that may be useful for correlating the failure reports with other factors and variables. Without going into the computational details, in the example of FIG. 4B, back end system 300 is preferably able to correlate the concentration of GPS signal failure reports from mobile devices within vehicles 412, 422, 424, 426, and 428 with the accompanying time data and location data transmitted to back end system 300 by the respective mobile devices within the listed vehicles. Moreover, since the vehicles experiencing GPS signal disruption are in motion, back end system 300 preferably accumulates signal disruption reporting data over several minutes to help determine whether any possible cause of the disruption is mobile or static with respect to the surface of the earth.

Once the GPS signal failure data is suitably compiled and correlated with times and locations of the GPS signal failures, and if no other major GPS signal disruptions are occurring at the time the vehicles shown in FIG. 4B experience their respective GPS signal failures, back end system may reasonably suspect that some device is actively jamming GPS signal transmission, and that the jamming device is within the vicinity of the vehicles of FIG. 4B that are experiencing GPS signal disruption. If the disruption had faded as the vehicles pass fixed device 450, back end system 300 might reasonably suspect that fixed device 450 was a possible source of a signal that disrupted local GPS signal reception. However, if, as the data from FIG. 4B indicates, the GPS signal disruption persists even after the vehicles move a significant distance away from fixed device 450, an algorithm running within back end system 300 may reasonably exclude fixed device 450 as a suspected cause of the disruption, and may instead investigate vehicle (truck) 410 as being the cause of the disruption.

The above discussion is directed to correlating a plurality of GPS signal disruption events with the times and locations at which other GPS signal disruptions have occurred. However, it will be appreciated that GPS signal disruption occurrences may be correlated with factors other than, or in addition to, the time and place of other disruptions.

The discussion of FIGS. 4A and 4B is directed to an exemplary GPS jamming scenario in which the source of GPS signal jamming arises is a mobile vehicle proceeding along a public roadway. Thus, correlation of GPS signal failure reports (also referred herein as a GPS communication disruption signal) with the locations and times at which the various GPS signal failures occurred was sufficient to deduce a likely source of the disruption (i.e. truck 410). However, the times and locations of respective occurrence of GPS signal failures are only two data points of many that may be used to glean data useable in determining the cause of GPS signal failures.

Other types of data that may be correlated with reports of GPS signal failure include, but are not limited to natural disasters; weather events; and/or major news events (such as terrorist acts, declarations of war, and/or acts of war).

### Occurrences Reportable by Mobile Devices

The example of FIG. 4 is directed to reporting GPS signal reception failures by mobile devices within vehicles, or being carried by users while on foot. However, the present invention is not limited to reporting GPS signal reception failures. Additionally or alternatively, the mobile devices may report other events or conditions to back end system 300 including, but not limited to the following occurrences within the vicinity of a reporting mobile device: (a) the presence of radar detection activity in the vicinity of the reporting mobile device; (b) a sudden acceleration or deceleration of the mobile device; (c) a sudden change in temperature of the mobile device; (d) a traffic jam; (e) hazardous activity whether related to weather or human activity, such as a riot. In the case of (a) through (c) above, an application in the mobile device could be programmed to automatically report the presence of radar detection activity in the vicinity of the mobile device, since conditions (a) through (c) may be detected automatically by equipment included within the mobile device. However, for occurrences (d) and (e) above, user-initiated data entry may be needed to enter data describing the condition into the mobile device. A user may then instruct the mobile device to report the condition to back end system 300.

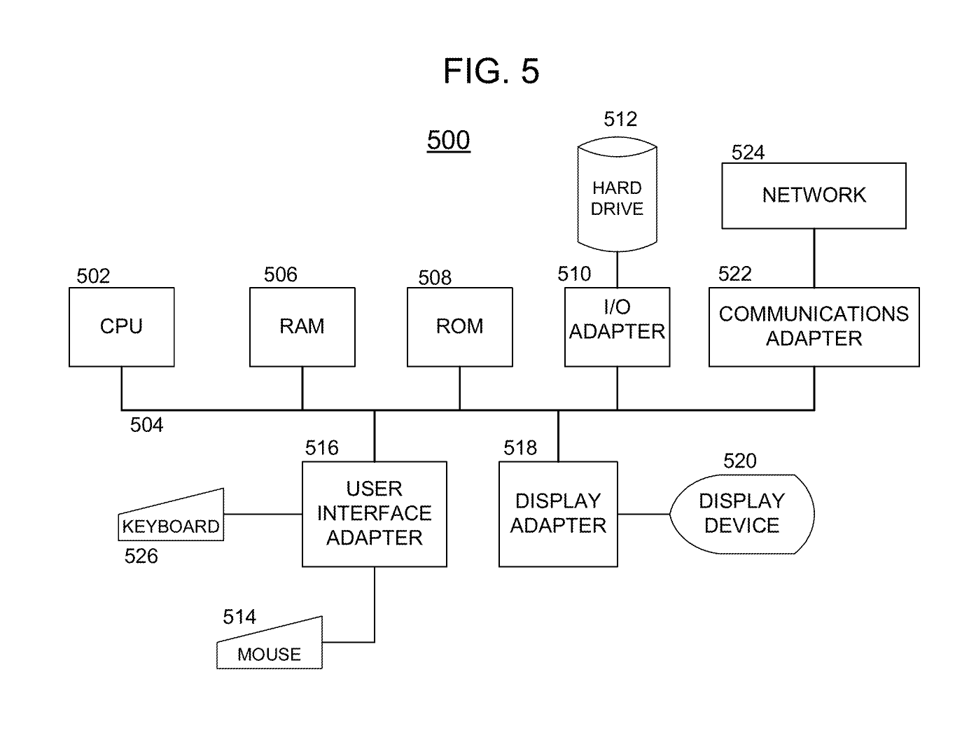

FIG. 5 is a block diagram of a computing system 500 adaptable for use with one or more embodiments of the present invention. Central processing unit (CPU) 502 may be coupled to bus 504. In addition, bus 504 may be coupled to random access memory (RAM) 506, read only memory (ROM) 508, input/output (I/O) adapter 510, communications adapter 522, user interface adapter 506, and display adapter 518.

In an embodiment, RAM 506 and/or ROM 508 may hold user data, system data, and/or programs. I/O adapter 510 may connect storage devices, such as hard drive 512, a CD-ROM (not shown), or other mass storage device to computing system 500. Communications adapter 522 may couple computing system 500 to a local, wide-area, or global network 524. User interface adapter 516 may couple user input devices, such as keyboard 526, scanner 528 and/or pointing device 514, to computing system 500. Moreover, display adapter 518 may be driven by CPU 502 to control the display on display device 520. CPU 502 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
providing a plurality of communication devices having access to the internet and respective GPS systems operable to communicate with a GPS satellite system; and
each said communication device transmitting a signal, indicative of GPS communication disruption, over the Internet to a back end system whenever (a) its GPS system is turned on; and (b) energy received through a GPS antenna of said communication device is below a level enabling a minimum signal to noise ratio needed for decoding GPS signal data.

2. The method of claim 1 wherein the providing step comprises:
providing a plurality of moveable communication devices having said access to the Internet and respective GPS systems.

3. The method of claim 1 wherein the providing step further comprises:
providing a plurality of fixed communication devices having said access to the Internet and respective GPS systems.

4. The method of claim 1 further comprising:
sending information to the back end system additional to the GPS communication disruption signal, the additional information including information describing the location of the communication device experiencing the GPS communication disruption.

5. The method of claim 4 further comprising:
determining the location information for a given communication device experiencing GPS communication disruption using one or more of the group consisting of:
(a) triangulation with information from a plurality of cell towers in communication with the given communication device;
(b) the SSID of a WIFI router providing Internet access to the given communication device; and
(c) a most recent location read of the location of the given communication device obtained by the GPS satellite system.

6. The method of claim 1 further comprising:
aggregating data from the respective GPS communication disruption signals at the back end system.

7. The method of claim 6 further comprising:
determining patterns of GPS communication disruption as a function of one or more of:
(a) time periods during which a disproportionate number of disruptions occur;
(b) geographical areas in which a disproportionate number of GPS communication disruptions occur;
(c) distinctive weather events during which, and in proximity to, a disproportionate number of GPS communication disruptions; and
(d) a disproportionate number of GPS communication disruptions occurring in proximity to a vehicle in motion on land, on water, and/or in the air.

8. The method of claim 1 wherein the transmitting step comprises:
the communication device automatically transmitting the GPS communication disruption signal upon detecting a combination of: (a) its GPS system being turned on; and (b) the energy received through a GPS antenna of said communication device is below a level enabling a minimum signal to noise ratio needed for decoding GPS signal data.

9. A system comprising:
a plurality of communication devices having access to the internet and respective GPS systems operable to communicate with a GPS satellite system over respective GPS antennas; and
each said communication device transmitting a signal, indicative of GPS communication disruption, over the Internet to a back end system whenever its GPS system is turned on but energy received through a GPS antenna of said communication device is below a level enabling a minimum signal to noise ratio needed for decoding GPS signal data.

10. The system of claim 9 further comprising:
a plurality of moveable communication devices having said access to the Internet and respective GPS systems.

11. The method of claim 9 wherein the providing step further comprises:
providing a plurality of fixed communication devices having said access to the Internet and respective GPS systems.

12. A method, comprising:
providing a plurality of communication devices having access to the internet;
each said communication device automatically transmitting a signal, indicative of a specified condition occurring in a vicinity of the communication device, over the Internet to a back end system whenever the communication device detects the specified condition, wherein the specified condition includes a presence of a speed detection radar signal in the vicinity of the communication device.
